(19) United States
(12) Patent Application Publication
(10) Pub. No.: US 2006/0289120 A1
(43) Pub. Date: Dec. 28, 2006

(54) Roller shutter box

(75) Inventor: Gunter Pielmeier, Bogen (DE)

Correspondence Address: PITNEY HARDIN LLP, 7 TIMES SQUARE, NEW YORK, NY, 10036-7311, US

(73) Assignee: Thyssen Polymer GmbH

(21) Appl. No.: 11/453,671

(22) Filed: Jun. 15, 2006

(30) Foreign Application Priority Data
Jun. 25, 2005 (DE) 10 2005 029 578.9

(51) Int. Cl. E06B 9/08

(52) U.S. Cl. 160/23.1

(57) ABSTRACT

The invention relates to a roller shutter box with a slat inlet and a centre bearing located between the two head pieces as well as an inspection cover, whose slat inlet in the head piece can be pushed parallel to the longitudinal axis of the roller shutter box or of the roller shutter shaft into any position and whose slat inlet can be pushed variably on the outer panel in a guiding groove parallel to the roller shutter shaft or the longitudinal axis of the roller shutter box and that is secured to an outer panel by means of a guide and fastening bracket of the slat inlet.

The invention relates to a roller shutter box with a slat inlet secured in a holder in the head piece with an additional holder for a fly screen or another blind, as well as an inspection cover and a frame connecting profile.

Roller shutter boxes of the type described are known as such. For example, DE 101 24 143 C1 shows a top-mounted roller shutter box that has a slat inlet, but which is designed to be stationary and cannot be adjusted to the different widths of the roller shutter slats. The same applies for the roller shutter box in accordance with EP 0 843 067 A2. Here too, there is no option whatsoever for using wider, narrow or even divided roller shutter slats. Further roller shutters boxes can be seen in, among others, AT 389 735B with a slat inlet which is inserted in the roller shutter guide and can only be shifted together with the latter, DE 295 07 267 U1, which refers to fixed rollers, DE 86 20 947 U1, which refers to the support of a central bearing, and DE 198 51 212 A1, which concerns an inspection cover.

The invention as described in the Claims is therefore based on the task of eliminating the disadvantages of the known roller shutter boxes and possessing a roller shutter box whose slat inlet can be adjusted to different dimensions, such as for example different widths, but also to slats with single or multiple divisions.

The advantages achieved with the invention are, on the one hand, trouble-free installation, simple sliding and adjustment of the width of the roller shutter slat inlet to different roller slats—even on the construction site, and on the other hand the possible adjustment or also division of the inlet to one or also more slats. Furthermore, there is provision for an inspection cover, which instead of a screwed connection is fitted with a snap-in mechanism for the frame connecting profile, which significantly facilitates installation, opening and closing.

The invention is described in greater detail in the following with the help of the embodiment shown in the illustrations.

It shows:

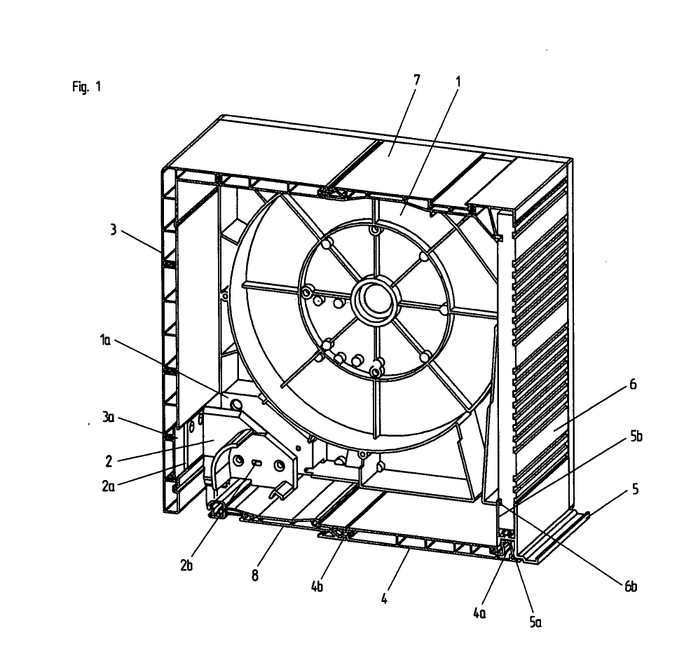

FIG. 1: A perspective view of the head piece of a roller shutter box in accordance with the invention,

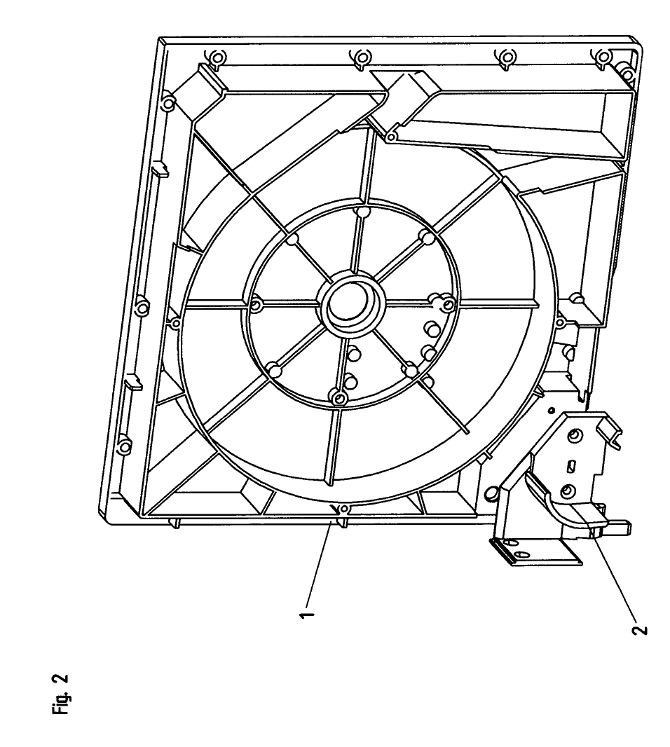

FIG. 2: a similar view of the slat inlet,

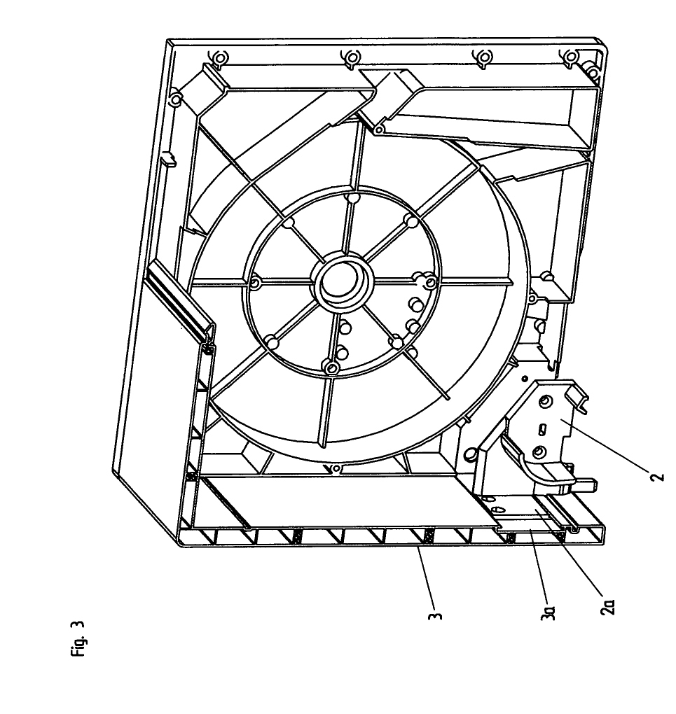

FIG. 3: a variant embodiment of FIGS. 1 and 2,

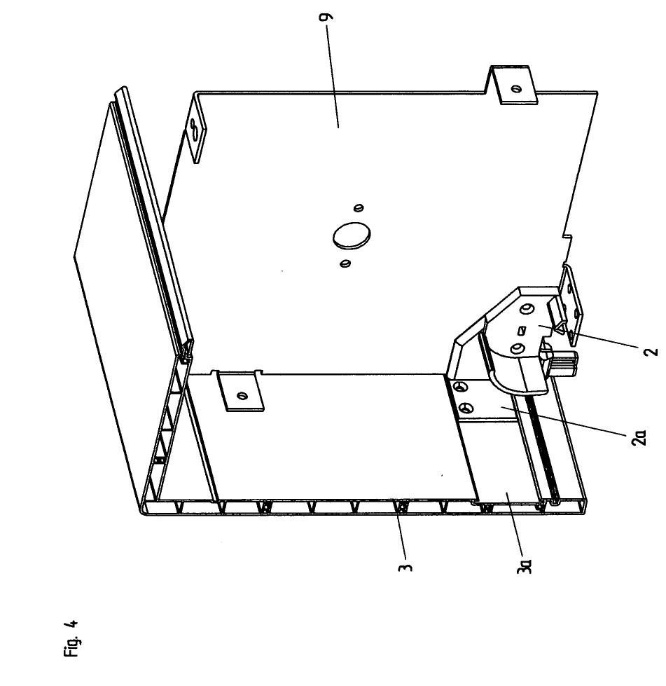

FIG. 4: a further variant embodiment

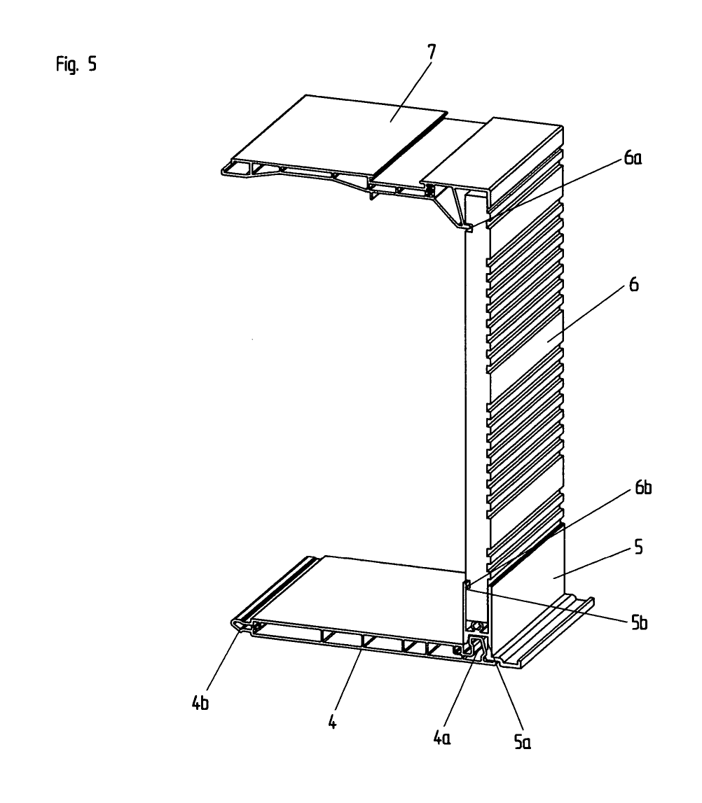

FIG. 5: the inspection cover and

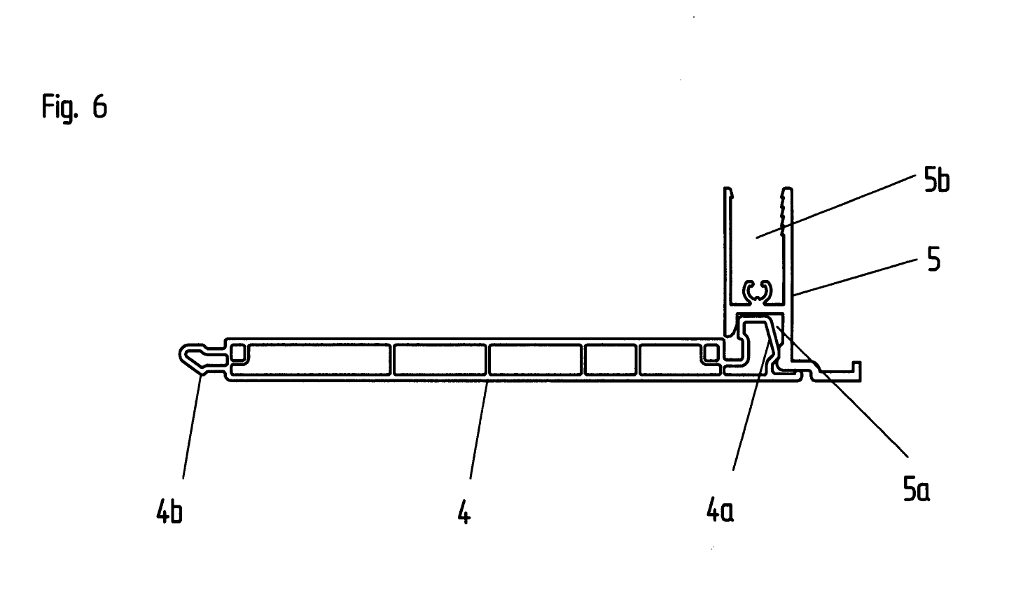

FIG. 6: the catches for the inspection cover.

As shown in the illustrations, the head piece 1 is fitted with a holder I a for the slat inlet 2, which has a guide and fastening bracket 2a and a holder 2b for an additional blind such as a shade, fly screen or the like. Furthermore, there is an outer panel 3 there with a guiding groove 3a for the fastening bracket 2a of the slat inlet.

At the bottom right the roller shutter box has an inspection cover 4 which is fastened to the plaster plate 5 with a catch 4a and to the frame connecting profile 8 with a catch 4b. It is not necessary to secure the inspection cover 4 using additional screw connections. A catch groove for the inspection cover 4 is designated 5a, and a similar groove for the connection of the inspection cover to the lath plate 6 is designated 5b.

A connecting profile 7 serves to connect the outer panel to the lath plate 6 located opposite. The centre bearing is designated as 9.

FIG. 2 shows the slat inlet 2, which is fastened to the head piece 1 in the holder 1a, whereby the same is illustrated on the bottom left.

FIG. 3 shows that the slat inlet 2 in the guiding groove 3a of the outer panel 3 can be pushed to any position and is attached to the outer panel 3 of the roller shutter box 1 with the guide and fastening bracket 2a of the slat inlet 2.

A variant embodiment is shown in FIG. 4. There, the slat inlet 2 is fastened on both sides of the centre bearing 9 of the head piece 1.

LIST OF REFERENCE NUMBERS

| | | | | | |
|---|---|---|---|---|---|
| 1. | Head piece, | 1a. | Holder for slat inlet 2, | | |
| 2. | Slat inlet, | 2a. | Guide and fastening | 2b. | Holder |
| | | | bracket, | | for blind |
| 3. | Outer panel, | 3a. | Guide for fastening | | |
| | | | bracket 2a, | | |
| 4. | Inspection cover, | 4a. | Catch, | 4b. | Catch, |
| 5. | Plaster plate, | 5a. | Catch groove, | 5b. | Catch |
| | | | | | groove, |
| 6. | Lath plate, | | | | |
| 7. | Connecting profile, | | | | |
| 8. | Frame connecting | | | | |
| | profile, | | | | |
| 9. | Centre bearing | | | | |

1. Roller shutter box with a slat inlet and a centre bearing located between the two head pieces as well as an inspection cover, wherein said slat inlet (2) in the head piece (1) can be pushed parallel to the longitudinal axis of the roller shutter box or of the roller shutter shaft, and that the slat inlet (2) can be pushed variably on the outer panel (3) in a guiding groove (3a) parallel to the roller shutter shaft or the longitudinal axis of the roller shutter box and is secured to an outer panel (3) by means of a guide and fastening bracket (2a) of the slat inlet (2).

2. Roller shutter box in accordance with claim 1, wherein said slat inlet (2) is fastened on both sides to the centre bearing (9) of the head piece (1).

3. Roller shutter box in accordance with claims 1 or 2, wherein an inspection cover (4) is provided, said inspection cover engaging by means of a catch (4a) in the catch (5a) of a plaster plate (5) and on the opposite side in the frame connecting profile (8) with a catch (4b).
